(19) United States
(12) Patent Application Publication
(10) Pub. No.: US 2004/0204983 A1
(43) Pub. Date: Oct. 14, 2004

(54) Method and apparatus for assessment of effectiveness of advertisements on an Internet hub network

(76) Inventors: David Shen, Cupertino, CA (US); John Boyd, San Jose, CA (US); Paul Kim, San Jose, CA (US); Christian Rohrer, Pacific Grove, CA (US)

Correspondence Address: FROMMER LAWRENCE & HAUG, 745 FIFTH AVENUE- 10TH FL., NEW YORK, NY, 10151, US

(21) Appl. No.: 10/633,168

(22) Filed: Aug. 1, 2003

Related U.S. Application Data
(60) Provisional application No. 60/461,904, filed on Apr. 10, 2003.

(51) Int. Cl. G06F 17/60

(52) U.S. Cl. 705/10; 705/14

(57) ABSTRACT

A method and computer application for assessing the performance of advertisements and in particular internet advertisements. The method includes collecting objective data points, subjective data points and user experience data points. Additionally, the method includes collecting advertisement description data points, creative description data points and user description data points. With these data points performance scores are calculated for assessing the effectiveness of an advertisement.

### CROSS-REFERENCE TO RELATED APPLICATION

This application claims the benefit under 35 U.S.C. § 119(e) of U.S. Patent Application No. 60/461,904, filed Apr. 10, 2003 under 35 U.S.C. § 111(b).

### BACKGROUND OF THE INVENTION

1. Field of the Invention

The present invention teaches a method and discloses an apparatus for assessing the effectiveness of an advertisement on a telecommunications network system such as the Internet, an intranet, an extranet and the like. The present invention also teaches the presentation of assessment data.

2. Description of the Related Art

There are a wide variety of tools presently available for assessing an effectiveness of an advertisement. The study of Internet advertisement is made easier by the fact that much of the information necessary for assessment is already in digital or computerized form. This allows that information or data to be mined and used to compute assessment metrics automatically.

Many of the tools for assessing an Internet advertisement focus on the objective indicia of effectiveness. These include the number of impressions, the number of clicks, the click through rate (CTR), and conversions for the advertisement. The number of clicks refers to the total number of times that an advertisement is clicked on by viewers. Impressions refer to the number of times an advertisement is presented to a viewer. The CTR is the number of clicks on an advertisement compared with the number of impressions. CTR is typically expressed as a ratio of clicks per hundred, thousand or million impressions. Conversions are instances where a viewer of an advertisement clicks on the advertisement and actually makes a purchase. These indicia are typically used to determine a price for an advertisement and to assess the value of the advertisement to an advertiser. Many of these metrics or tools were developed for the advertising industry to assist in determining the effectiveness of an advertisement.

The objective indicia are useful in determining the effectiveness of an advertisement from the advertiser's perspective. Traditionally it was thought that the higher the CTR and conversions, the greater the effectiveness of the advertisement. While this may or may not be true, clearly those objective indicia do not provide a complete picture of effectiveness for an advertiser or media owner (hereinafter “Evaluator”) of the advertisement. CTR and conversions do not provide any indication of why a certain advertisement is effective nor do they provide any indication of what users who saw the ad thought and felt about it. For this, two additional tools are used, user feedback to assess the subjective impression the advertisement creates, and descriptions of the content of an advertisement.

The subjective impressions of viewers regarding an advertisement collected from user feedback are useful because they indicate why the advertisement was effective, for example because it is perceived as humorous, shocking, annoying, etc. These factors cannot be captured by the objective indicia discussed above. By understanding why the particular advertisement creates a response in the viewer, advertisement professionals can tailor the content and the presentation of the advertisement. Subjective impressions are typically collected using viewer surveys. Interpretation of survey results presents its own difficulties, often requiring arduous and costly processing to extract statistically useful information about the advertisement.

Finally, the characteristics of the advertisement itself are useful in understanding effectiveness. For example, the brightness, movement, sounds, themes and size of the advertisement, and when, where and how it is presented to viewers all affects an advertisement's effectiveness. These factors may not be ascertainable from the viewer feedback, further they do not fit into the category of the traditional objective indicia of effectiveness. These factors are often referred to as ad descriptions and content descriptions.

While the objective indicia, user feedback, ad descriptions and content descriptions are known ways to judge advertising effectiveness, these factors are typically viewed in isolation. For example, an Internet web-site owner may adjust the price of advertising space to new advertisers based on the average CTR of its current advertiser's advertisements. In another example, an advertiser may consider its ad successful, based on a high CTR, but be unaware that the advertisement is perceived as annoying by viewers, thus tarnishing the image of the product and possibly the website in the marketplace.

Further, because of the complex nature of on-line advertising it may be the combination of objective, subjective, and descriptive elements that render an advertisement effective. Current advertisement assessment means do not enable an advertiser or web-site owner to perform a complete analysis considering all of these factors. Accordingly, there is a need for a method and apparatus that overcomes the problems associated with prior art advertisement assessment methods.

### SUMMARY OF THE INVENTION

The present invention provides a method and apparatus for assessing the performance of an advertisement combining objective indicia, subjective indicia and content descriptions.

According to one aspect of the invention, these indicia and descriptions are mathematically combined to yield one or more metrics that reflect advertising effectiveness.

According to another aspect of the invention, there is provided a method whereby input and outcome data points are collected and performance scores are calculated. According to yet another aspect of the invention, the performance scores are used to compare the relative effectiveness of two or more advertisements.

According to still another aspect of the invention, the performance scores are calculated on the basis of input data points that include advertisement description data points, creative description data points, and user description data points. The performance scores include objective performance scores, subjective performance scores, and user experience performance scores.

According to a further aspect of the invention, metrics of the advertising effectiveness include calculated performance scores that are presented through a computer-based application. The performance scores include an composite performance score, a user experience score, a subjective performance score, and an objective performance score. The performance scores are calculated based on data points, including advertisement description (ad description) data points and the creative description data points that are downloaded from external data collection databases. According to another aspect, these scores and data points are viewable by an advertiser on the computer-based application.

According to a still further aspect of the invention, the subjective performance scores and user experience performance scores are calculated using surveys. The surveys are presented to users via a button or link associated with the advertisement. The survey may be presented as a pop-up window that prompts a viewer to select multiple-choice responses to questions. The surveys may also prompt the viewer to provide text comments, regarding the advertisement.

According to another aspect of the invention, the user feedback results are evaluated in view of a description of the user himself/herself. User description data points are determined from cookies stored locally on a user's interface device. According to a further aspect, the survey itself prompts the user for additional user description data.

Further characteristics, features, and advantages of the present invention will be apparent upon consideration of the following detailed description of the invention, taken in conjunction with the following drawings, and in which:

### BRIEF DESCRIPTION OF THE DRAWINGS

FIG. 1 is a graphical view of data sources according to an embodiment of the present invention;

FIG. 2 is an initial web page according to an embodiment;

FIG. 3 is a survey web page according to an embodiment;

FIG. 4 is a web page showing a link to the survey web page as shown in FIG. 3 according to an embodiment;

FIG. 5 is an HTML translation of the survey shown in FIG. 3;

FIG. 6 is a graphical representation of a composite score of advertisements by position according to an embodiment;

FIG. 7 is a table representation of the frequency scores of advertisements according to an embodiment;

FIG. 8 is a table of annoyance scores according to an embodiment;

FIG. 9 is a web page showing of data sources of an embodiment;

FIG. 10 is a web page showing survey results sorted by the number of times a viewer has seen the advertisement according to an embodiment;

FIG. 11 is a web page showing entry to Today's Reports according to an embodiment;

FIG. 12 is a web page presenting results determined according to an embodiment;

FIG. 13 is a web page showing feedback scores according to an embodiment;

FIG. 14 is a web page showing entry to the Latest Best Performer's Reports according to an embodiment;

FIG. 15 is a web page presenting further results determined according to an embodiment;

FIG. 16 is a diagram of a system workflow according to an embodiment;

FIG. 17 is a block diagram of a system architecture according to an embodiment;

FIG. 18 is a web page of options and settings for an embodiment;

FIG. 19 is a web page screen for creating a new column formula according to an embodiment;

FIG. 20 is a web page providing access to a column formula according to an embodiment;

FIG. 21 is a web page for creating custom reports according to an embodiment; and

FIG. 22 is a web page for constraining data presented according to an embodiment.

### DETAILED DESCRIPTION OF THE INVENTION

An accurate determination of an advertisement's effectiveness is important to both advertisers and media owners. For example, a media owner armed with accurate information is better able to determine how much to charge for an advertisement. Further, the media owner is able to determine the positive or negative impact the advertisement will have on the user's experience and the user's view of the media owner's brand. For example, a highly annoying advertisement may have a negative impact on the user's view towards the media owner that displays the advertisement, or allows a particular advertisement method to be used on their media. Detection of annoying advertisements is particularly important because there is an Internet trend toward more intrusive rich media advertisements such as “pop-ups.” Currently, there are no known systems for assessing the short or long term impact these intrusive rich media have on a user's experience, branding, and web-site usage. Similarly, an advertiser with access to such information is better able to determine whether to begin advertising in a particular location or in a particular medium, whether to continue advertising in a particular place or in a particular fashion, and whether the cost of the advertisement is justified.

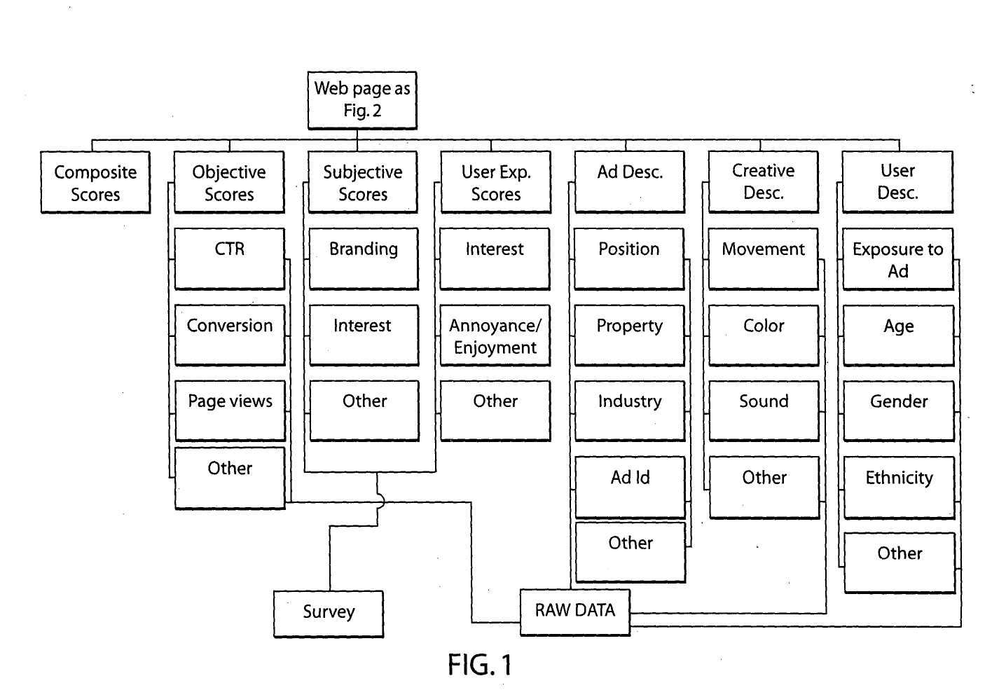

Accordingly, one embodiment of the present invention is directed to a method for assessing the effectiveness of an advertisement and presenting the assessment to an Evaluator. The method incorporates objective and subjective information as well as advertisement and content description information in a unified presentation. FIG. 1 shows an example of such a presentation implemented as a series of inter-linked HTML documents. This information is gathered from a variety of sources and quantified to generate a number of variables. These variables provide a basis for calculations to compute performance scores. These performance scores can be used to compare the effectiveness of two or more advertisements and to assess the effectiveness of an individual advertisement both in terms of user experience score and the subjective performance score. These scores can also be used in conjunction with the objective performance scores such as CTR and objective values such as the page views that have traditionally been the basis of financial considerations for Internet advertising. The performance scores, variables, and values used in the calculations are all classified as data points, and can be used in conjunction for calculations, as will be seen below.

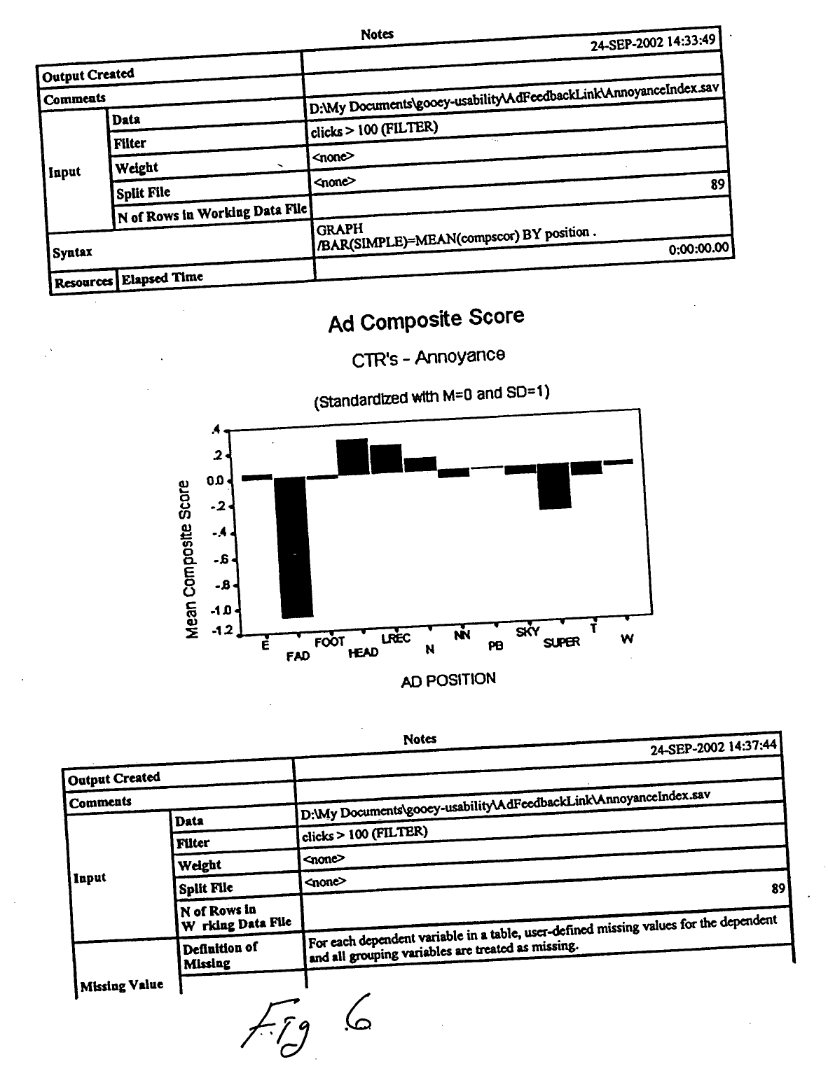

One aspect of the present invention enables performance scores and the underlying data from which the performance scores are calculated to be presented to an Evaluator. The data can be grouped and re-grouped depending upon the preferences of the Evaluator. For example, FIGS. 6-15 show some of the groupings of data or data points including outcome and input variables.

With respect to the groupings of the data, the outcome variables quantify the performance of advertisements and are further broken down into a plurality of classifications. The classifications of outcome variables include objective outcome variables such as CTR, impressions, conversions and the like. Subjective outcome variables include the degree of branding associated with the advertisement, and user experience outcome variables. One user experience variable is the degree users enjoy or are annoyed by the advertisement, as shown in FIG. 1.

According to one aspect of the present invention, data are grouped into two general categories, outcome variables and input variables. The input variables represent the features that go into the advertisement including, the position, movement, and user description. The outcome variables are the results of an advertisement. These include the number of clicks on an internet advertisement, the number of times an advertisement is presented to viewers, the perceived annoyance of the advertisement and others. One aspect of the present invention is to quantify all of these variables and utilize their values in conjunction with a plurality of metrics or formulae to calculate a series of performance scores. The performance scores enable a quantifiable comparison of advertisements with one another.

The objective outcome variables are data associated with the advertisement being presented to viewers. For instance, the impressions of the advertisement represent the total number of times that an advertisement has been presented to all viewers or to a specific viewer. This tells the advertiser how many users have seen the advertisement. The objective outcome variables form part of the calculation for the composite performance score of the advertisement as well as forming the basis for the objective outcome scores, discussed below.

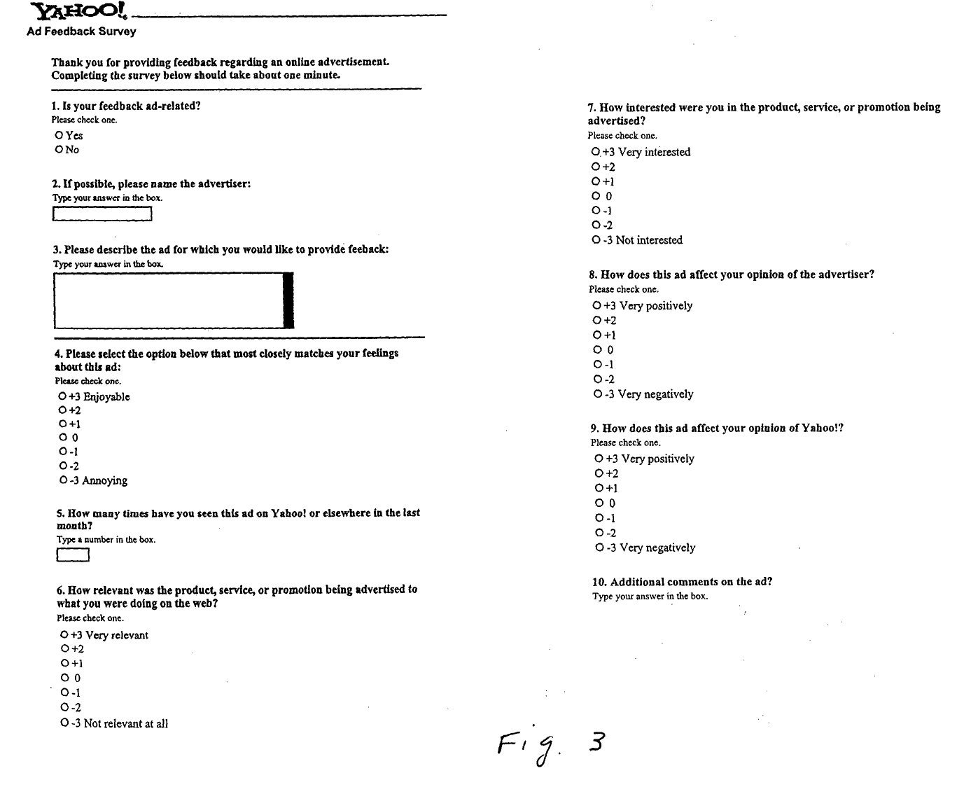

The subjective outcome variables represent psychological factors that express the effectiveness of an advertisement. Subjective outcome variables include emotional responses viewers have to the advertisement, including annoyance, relevance, interest in the subject matter of the advertisement, the effect of the advertisement on the viewer's regard for the advertiser, and the viewer's knowledge of the advertiser or the product. These factors represent the viewer's impressions and opinions regarding either the product or the advertisement, which lead the viewer to click on the advertisement and to purchase the advertised product. According to one aspect of the invention surveys or electronic surveys such as that shown in FIG. 3 are utilized to gather the data related to the subjective outcome variables.

Use of a survey, particularly an electronic survey, allows for the subjective opinions of the viewer to be expressed in an electronic form that is easily quantified. The survey may include multiple-choice questions that allow the user to rate various features of the advertisement. These are transformed to quantities that are used to calculate performance scores. For example, the survey shown in FIG. 3 collects information regarding whether the advertisement is “enjoyable” or “annoying.”

Additionally, the survey shown in FIG. 3 includes a portion that asks for text comments from a viewer, providing useful information for the advertiser. Text can be transformed into quantifiable information, for example, by automatically searching for key words, e.g. “great” or “annoying”, etc., and associating a value to such words. Text may also be collected and presented to an Evaluator as un-quantified information. These subjective outcome variables form part of the calculation for the composite performance score of the advertisement as well as forming the basis for the subjective performance scores.

The degree viewers consider an advertisement annoying or enjoyable is an important measure of the advertisement's effectiveness. It is possible that a highly annoying advertisement may also be highly effective because it will be likely to get the attention of the user and be memorable. Often, however, an annoying advertisement will not lead a user to purchase the product, and may leave the user with a negative impression of the product, the advertiser, and/or the media owner. Accordingly, this variable provides important information to the Evaluator. It should be apparent to one of skill in the art that annoyance and enjoyment of an advertisement are inversely proportional. Therefore, one could readily describe the annoyance score as an enjoyment score. To avoid such confusion, this subjective outcome variable is herein referred to as the User Experience Score (UES). According to one embodiment of the invention a UES is calculated as follows:

$$UES = [ ( \frac{Occurrence}{Pageviews} ) * ( 1 , 000 , 000 ) ] \qquad ( Expression 1 )$$

Where:

Occurrence=the performance of some event, for example, completion of a survey

Pageviews=the number of times that an advertisement has been viewed

Expression 1 is presented by way of example. Other formulae could be used to compute the UES based upon survey results within the scope of the invention. For example, the UES can also be calculated as follows:

$$UES = Z [ ( \frac{Occurrence}{Pageviews} ) * ( Z ( q .4 ) ) ] \qquad ( Expression 2 )$$

Where: q.4 (or q.n)—refers to the answer of one of the numbered questions from the survey results as shown in FIG. 3, in this case question 4. These survey results are given a numerical value and incorporated into the calculation. Where a survey question q.n. measures annoyance or enjoyment, UES provides a metric for how favorably the viewer considered the advertisement.

Z is a factor that normalizes the score and/or converts it into standard units. Z may be calculated using various statistical techniques. According to one embodiment Z is used to transform the raw data to a distribution with a mean of 0 and a standard deviation of 1. According to this embodiment Z is:

Z=(x−M)/SD

Where:

x=a raw score

M=the mean of the raw scores; and

SD=the standard deviation of raw scores

The survey in FIG. 3 also seeks information concerning the relevance of an advertisement (question 6), and the impact of an advertisement on the viewer's opinion of the advertiser (question 8) or the media owner (question 9). The advertiser and web site brand scores refer to positive or negative impact of an advertisement on the viewer's perception of the advertiser or the media owner, respectively computed based on responses to the survey. According to one aspect of the present invention, relevance, media brand and advertiser brand scores are calculated in a manner similar to Expression 1 utilizing the survey data from questions 6, 8, and 9 respectively. The calculations for each of these metrics is as follows:

The relevance score (RS) may be calculated as:

$$RS = Z [ ( \frac{Occurrence}{Pageviews} ) * Z ( q .6 ) ] \qquad ( Expression 4 )$$

The advertiser brand score (ABS) can be calculated as:

$$A BS = Z [ ( \frac{Occurrence}{Pageviews} ) * Z ( q .8 ) ] \qquad ( Expression 5 )$$

The web-site brand score (WSBS) can be calculated as:

$$WSBS = Z [ ( \frac{Occurrence}{Pageviews} ) * Z ( q .9 ) ] \qquad ( Expression 6 )$$

A composite brand score (CBS) can be calculated as:

$$CBS = Z [ ( \frac{Occurrence}{Pageviews} ) * ( 2 * Z ( q .9 ) + 1 * Z ( q .8 ) ) ] \qquad ( Expression 7 )$$

The survey may also be used to collect information about the user's interest in the subject matter of the advertisement. An advertisement will be unlikely to produce positive results if it is not presented to its target audience. Accordingly, the relative interest of a viewer is an important factor for an advertiser to consider when they are paying for advertising space. According to one aspect of the present invention, data concerning user interest is collected using question 7 shown in FIG. 3. An interest score is calculated in a manner similar to Expression 1.

The interest score (IS) may be calculated as:

$$IS = Z [ ( \frac{Occurrence}{Pageviews} ) * Z ( q .7 ) ] \qquad ( Expression 8 )$$

As will be discussed below these scores are then used to calculate the composite performance score.

The survey may also solicit subjective comments. For example, question 10 in FIG. 3 asks for any additional comments. Some comments returned by viewers might include statements regarding the inappropriateness of an advertisement, or that the advertisement is perceived to be humorous.

Text comments may be collected as anecdotal data or may be analyzed to recognize key words such as “great,” “enjoyable,” “rude,” or “annoying.” Response scores to such keywords can be analyzed and in a manner similar to that shown in Expressions 1-8.

The user experience variables form part of the calculation for the composite performance score of the advertisement, as well as forming the basis for the user experience outcome scores, as will be discussed below.

In a further aspect of the invention, input variables quantify aspects of the advertisement itself and the user that impact the effectiveness of the advertisement. These include ad description, creative description, and user description, as shown in FIG. 1.

The ad description describes the features of an advertisement including, for example, the identity of the advertiser, the frequency of the advertisement display, its size, its position in the media, the number of other advertisements at the same location, the total area of advertisements at the media location, the run dates and length, the time of day, and other typical advertisement considerations. Each of these factors is given a value that is included in the calculation of the performance scores of the advertisement.

The creative description includes many of the visual and intellectual features of the advertisement, for example, color, sound, movement or animation, contrast, brightness, humor, creativeness of the advertisement, interest in the product, and the relevance of the product to the viewer. Each of these factors is given a value that is included in the calculation of the performance scores of the advertisement.

The user description represents a description of each viewer that views the advertisement. The user description may include the number of exposures of the advertisement to a particular viewer, frequency of that exposure, and the viewer's gender, age, ethnicity, geographic location, income, Internet experience and IP address. Each of these factors is given a value that is included in the calculation of the performance scores of the advertisement. Much of this information is taken from the user's cookies. There are at least two types of cookies that can be queried according to this embodiment of the present invention. The first are referred to as B cookies or browser cookies. B cookies simply record where on the web the browser has accessed but do not identify the person using the browser. The second are L cookies. L cookies, or log-in cookies are created when a user registers with a service such as Yahoo!. L cookies allow the service to know exactly who is using their service and what parts of the service the user is accessing. In registering for the service, the user provides much more information about the himself/herself such as age, sex, marital status, hobbies, and the like. This information is stored in a database operated by the service provider. In an instance where the service provider is also the Evaluator, the information in the L cookies is used to provide more input variables regarding the user description and enables a more complete picture to be formed of the person responding to the survey. Other data may also be available where the user is a member of a premier service offered by the service provider. These premier services often require the user to provide extra information that is used to tailor the service to their needs. Where the person completing the survey is also a premier service member, this information can also be incorporated into the calculation of performance scores.

The above-described values are used to compute a composite performance score that describes the effectiveness of an advertisement. The composite performance score represents a value for comparison to other advertisements.

As shown in FIG. 1, the composite performance score is available as part of the presentation. The composite performance score (CPS) may be calculated as follows:

CPS=Z[(Occurance/pageviews)*Z(UES)] (Expression 9)

Where: Occurrence=the number of times a survey is completed;

Pageviews=the number of times that an advertisement has been viewed;

UES=a value derived from the survey data relating to how annoying or enjoyable an advertisement is perceived by the viewers;

Other calculations for the composite performance score based on each of the outcome scores found, for example, using Expressions 2, 5, 6, and 11 (discussed below) are also possible within the scope of the present invention. For example, composite performance score may be calculated based on a weighted combination of these values, as follows:

CPS=Z[a*(OPS)+b*(UES)+c*(ABS)+d*(WSBS)] (Expression 10)

Where: a, b, c, and d represent a weighted multiple that have been empirically determined for calculating CPS. According to one embodiment of the invention a=6, b=3, c=1, and d=2. Of course other weighting values may be used.

Other performance scores can be calculated as follows:

The objective performance score (OPS) may be calculated as:

OPS=Z(CTR) (Expression 11)

The subjective performance score (SPS) may be calculated as:

$$SPS = Z [ ( \frac{Occurrence}{Pageviews} ) * ( \frac{Z ( q .4 ) + Z ( q .8 ) + Z ( q .9 )}{3} ) ] \qquad ( Expression 12 )$$

According to a second embodiment of the present invention, the method described above is implemented on a computer network. Such a network includes the Internet, an Intranet, Extranet, and the like. Presentation of advertisement and surveys to viewers may be via an interactive web page implemented on a server. An Evaluator views the results, including performance scores and the underlying data via the interactive web page. One example of such a network is the Mercury system owned and operated by Yahoo!.

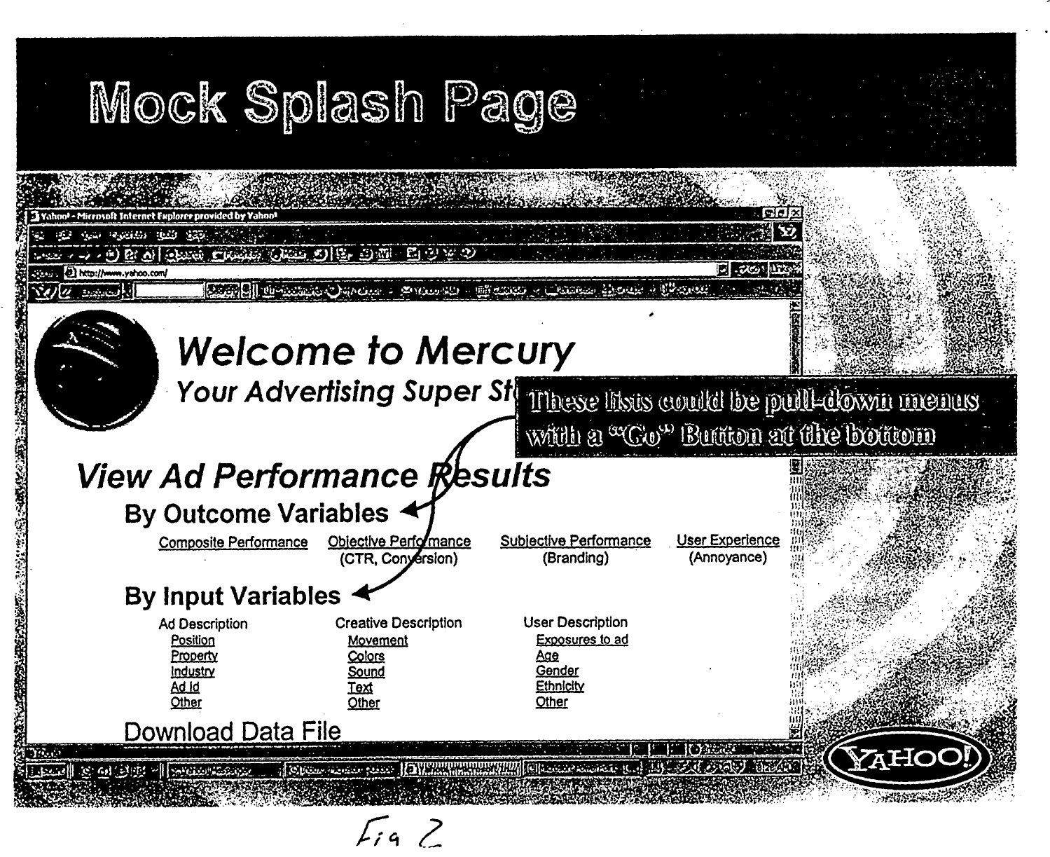

Advertisement performance scores are calculated and updated on a regular basis. The results are displayed to Evaluators on the World Wide Web, or the Internet, as a shown in FIG. 2. FIG. 2 depicts a web page that provides access by an Evaluator to data regarding an advertisement. Each of the groupings of data provides access to further data and/or calculations.

The web page, as show in FIG. 2, provides a plurality of different types of data groupings available to an Evaluator. The underlying data for each of the groupings is collected via the computer network. The underlying data are used to calculate a plurality of performance scores, including those described above. The calculated performance scores enable an Evaluator to assess the effectiveness of an advertisement, an advertisement location, an advertisement composition, and the like.

One set of data shown in FIG. 1 are outcome variables, including the CTR, the number of clicks on an advertisement, and the number of viewer impressions of the advertisement. In one aspect of the present invention these variables are determined by imbedding counters in the Web site or the advertisement and performing calculations based upon the counter values. The counter values indicate how many users have seen the advertisement, as well as the number of users who clicked on the advertisement. CTR represents a ratio of users that viewed an advertisement to the number of users who clicked on the advertisement.

According to another embodiment of the invention, surveys such as the one shown in FIG. 3 are presented to users along with the advertisements. The surveys are presented in two primary methods, although others may be utilized without departing from the scope of the present invention. The first is through pop-up windows that a visitor to a Web site automatically receives. The pop-up window prompts the user to fill out the requested information. According to another aspect of the invention the user may be given an incentive to provide information, such as a gift or a discount. A pop-up window is a separate Web page presented after a user enters a first Web page. The user is prompted to fill out the survey and the server collects the results from the survey.

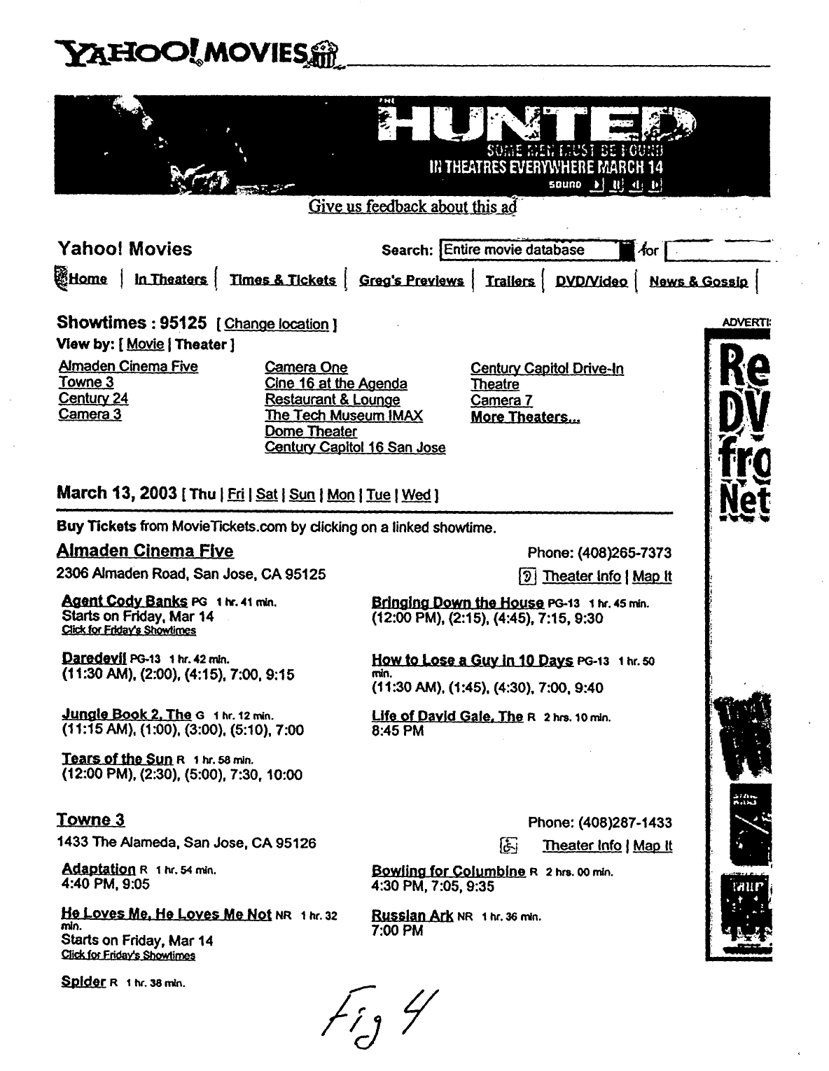

A second method for presenting the survey is to include a link for “Ad Feedback,” as shown in FIG. 4. The link may be a part of the web page appearing in the header or footer, for example, or may be imbedded in the advertisement itself. By clicking on the link, a user is directed to the survey. The information entered in the survey is sent back to and collected by a server.

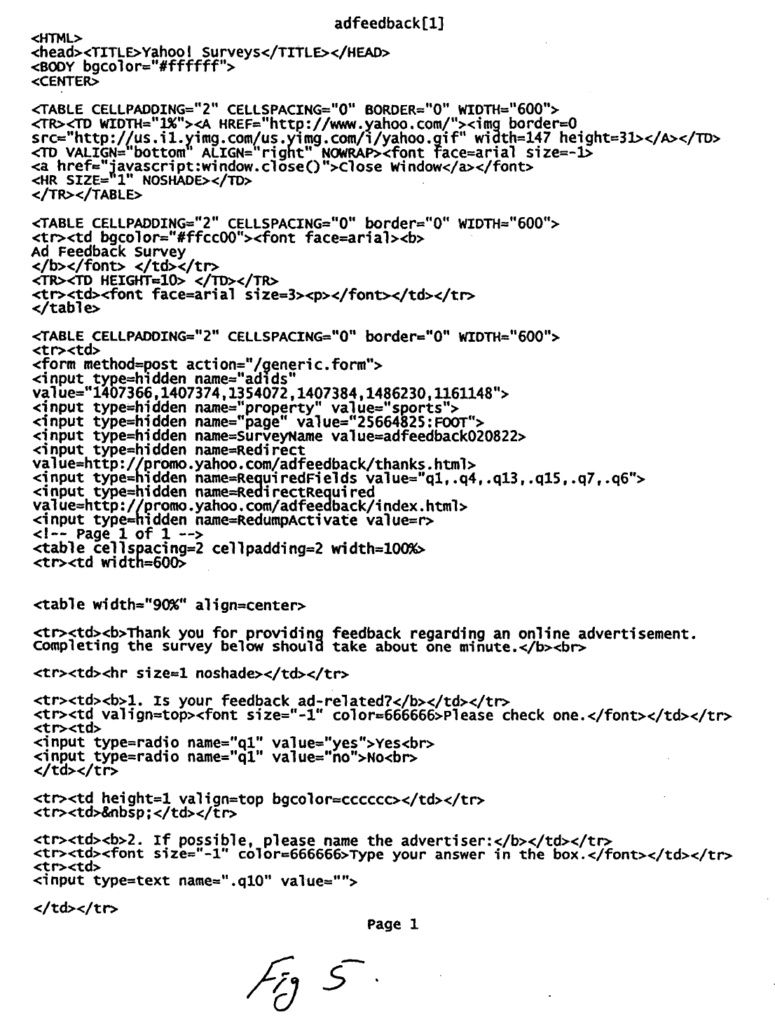

The survey data are in electronic form, for example, an HTML document or the like that can be stored on the server and presented to the user according to a variety of known techniques. Likewise, survey results are collected in electronic form and stored by the server according to a variety of known techniques. Storage of survey results may be the form of an HTML document web page such as that shown in FIG. 5.

According to this embodiment, the server also collects input variables. Input variables related to ad description include, for example, the identity of the advertiser, the frequency of the advertisement display, its size, its position on the web site, the number of other advertisements on the same web page, the total area of advertisements on the web page, the run dates and length, the time of day, and other typical advertisement considerations. Inspecting cookies resident on a user's access device collects input variables related to user description. These cookies include both L and B cookies and provide information about the user and websites the user has previously viewed.

According to another embodiment of the invention an Evaluator is able to access the actual survey responses as well as view the performance scores calculated therefrom. Accessibility to the underlying data enables a layered approach to viewing the data by the Evaluator. Accordingly, by clicking on outcome performance, a plurality of data and calculations are available for review. These data and calculations provide further access to other underlying data points. As a result, all of the data collected regarding an advertisement is accessible to the Evaluator. Moreover, the Evaluator can compare one advertisement to another based upon selected criteria. FIG. 1 demonstrates the layering of the data. Specifically, FIG. 1 shows the overall accessibility of the data from the screen page, as shown in FIG. 2. All of the data collected from the various databases can be viewed either as raw data or in analyzed form as the performance scores.

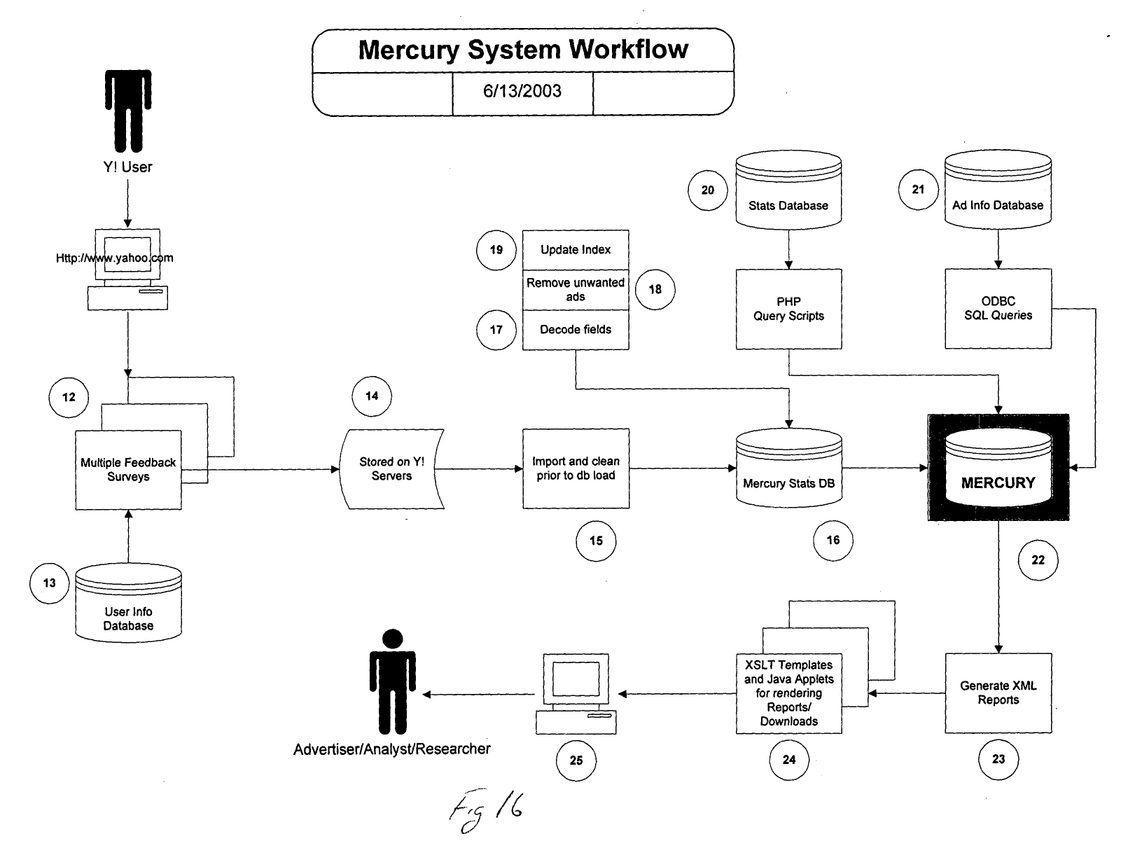

According to one embodiment, a computer application according to the present invention downloads the input variables, which may be stored in databases maintained by the media owner, and survey results, which may be stored independently, as shown in FIG. 16. Accordingly, the present invention does not require additional or duplicative data collection means to perform the advertisement assessment tasks when connected to an existing advertising system.

In the preferred embodiment, the Evaluator accesses a Web site via the Internet, as shown in FIG. 2. An access-limiting device such as a password confirmation that requires subscribers to input an access code prevents unauthorized access. Once access is gained the Evaluator is able to view all of the collected variables and calculated scores.

For example, if the Evaluator wishes to see the overall performance of an advertisement they click on a link to the composite performance score. By doing so, the advertiser is directed to a subsequent Web page that provides the composite performance score. The pages are connected by hyperlinks associated with each of the variables or scores. The scores may be represented in graphical or table form for comparison to other advertisements, as shown in FIGS. 6-12. The application may provide various other information regarding groups of advertisements, such as the top five advertisements, the bottom five advertisements, the top and bottom five advertisement positions, or the top or bottom five advertisements displayed in a particular location. These tables or charts may be scaled over a particular time period. For example, if the advertisement has only been posted over the last ten days, that ten-day period represents the relevant time period for considering the effectiveness of the advertisement.

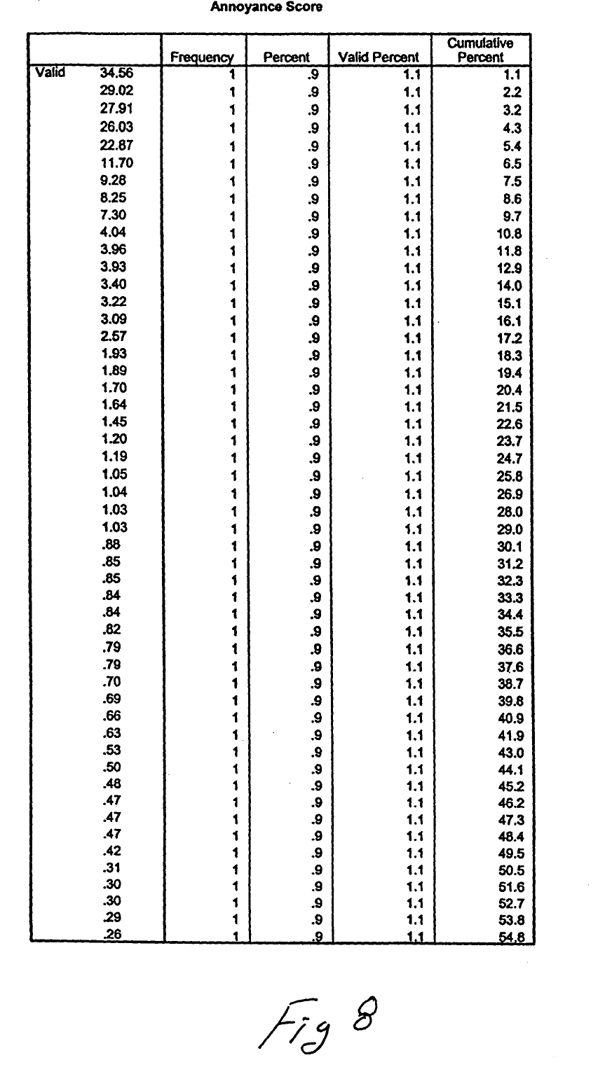

Similarly, the Evaluator may access the outcome variables. By clicking on the user experience link the Evaluator will see, for example, the UES of an advertisement. The application also provides for comparison with other advertisements, as discussed above with respect to the overall performance score, as shown in FIG. 8. Under each of the links, a plurality of calculations are provided to determine why the advertisement is effective with respect to the corresponding outcome variable. Similarly, the Evaluator can view other groupings of data that are relevant to assessing effectiveness of an advertisement. The Evaluator may also view the actual data used in the calculations.

As shown in FIG. 8, a Frequency Table lists the UES, or annoyance calculated for each advertisement identified by a unique Ad Id. The frequency of the UES refers to how often that specific UES occurred in the data. The “percent” column refers to the total percent of UESs that had that specific value. The “valid percent” column corrects the “percent” column to account for missing values. The “cumulative percent” column refers to the cumulative percent of UESs that are equal to or less than a specific value. The “valid cumulative percent” corrects the cumulative percent column to account for missing values.

A confidence interval may be calculated with respect to the UES or any other value or score to determine its statistical significance. The confidence interval is calculated using a statistical analysis application such as SPSS, a commercially available statistical analysis tool. According to one embodiment, the analysis is based on the mean and standard error of the mean of a UES frequency distribution. For example, the confidence interval allows an advertiser or media owner to identify ads that are statistically more or less annoying than other ads. By using the data provided in FIG. 8, the UES for a specific Ad Id is used to determine whether it falls outside of the confidence interval calculated as follows:

Confidence interval=Y±(Z_{α/2}(σ_{Y})

where

$$where \text{:} {σ}_{Y} = \frac{σ}{\sqrt{n}}$$

and refers to the standard error of the mean, which is equal to the standard deviation divided by the square root of the sample size;

Y=the mean of a performance score or value for which confidence interval is desired;

σ=standard deviation of Y;

Z_{α/2}=The z-score value for a desired confidence level is taken from a z-table (not shown). For the two most commonly used confidence levels, 95% and 99%, the z-score values are 1.96 and 2.59, respectively.

As an example, to calculate a 95% confidence interval for a UES, assuming the mean UES is 45, the standard error of the mean is 5, and given that the z-value in a table is 1.96 for a 95% confidence interval, the calculation is as follows:

45±(1.96)*(5)=35.2<Y<54.8

Accordingly, if another sample of data were taken to measure UES for the same advertisement with the same sample size, there is 95% confidence that the mean of the UES second sample will be between 35.2 and 54.8. Moreover, if the UES were measured for another advertisement using the same sample size, and the mean UES is greater than 54.8, there is a 95% confidence level that the second advertisement is perceived as more annoying than the first advertisement.

By clicking on the objective performance link, as shown in FIG. 2, the objective performance score is presented and may include comparisons to other advertisements. The objective performance score is calculated, for example, using the calculation for OPS in Expression 11, above. This score may be presented along with the underlying raw data. Likewise, where the subjective outcome link is selected, subjective performance score (SPS) are calculated for example, according to Expression 12, shown above, and presented to the Evaluator.

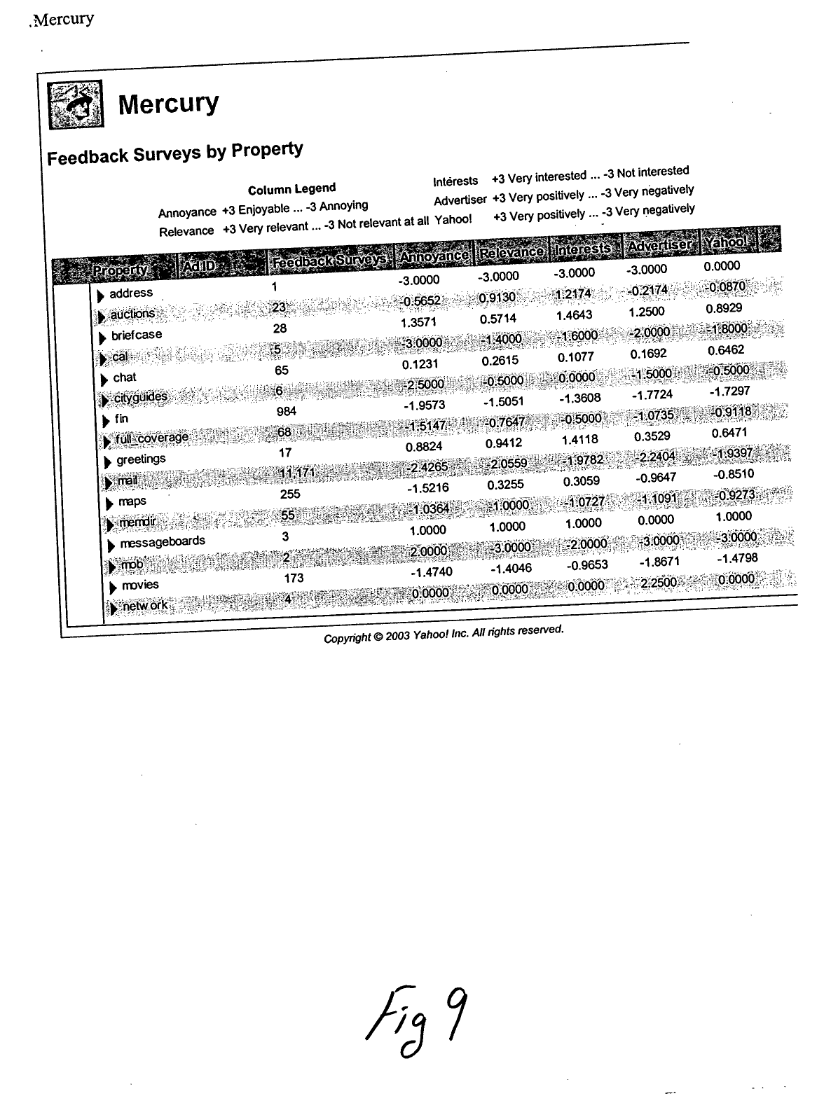

Selecting links to any of the input variables will present the specific variables that correspond to the advertisement. For example, as shown in FIG. 9, clicking on the property link shows the location of the advertisement, that is, the particular web page where the advertisement is displayed, e.g., on the auction page. Each location then has specific outcome values attributed to it. As a result, the advertiser is able to identify the locations that result in high performance, measured, for example, in terms of UES or the CPS. This enables the Evaluator to direct the advertisement to locations where it will be more effective.

Similarly, by clicking on a user type link in FIG. 2 the Evaluator is directed to a Web page (not shown) that displays certain information about viewers of the advertisement. This information is taken from both the surveys and cookie information.

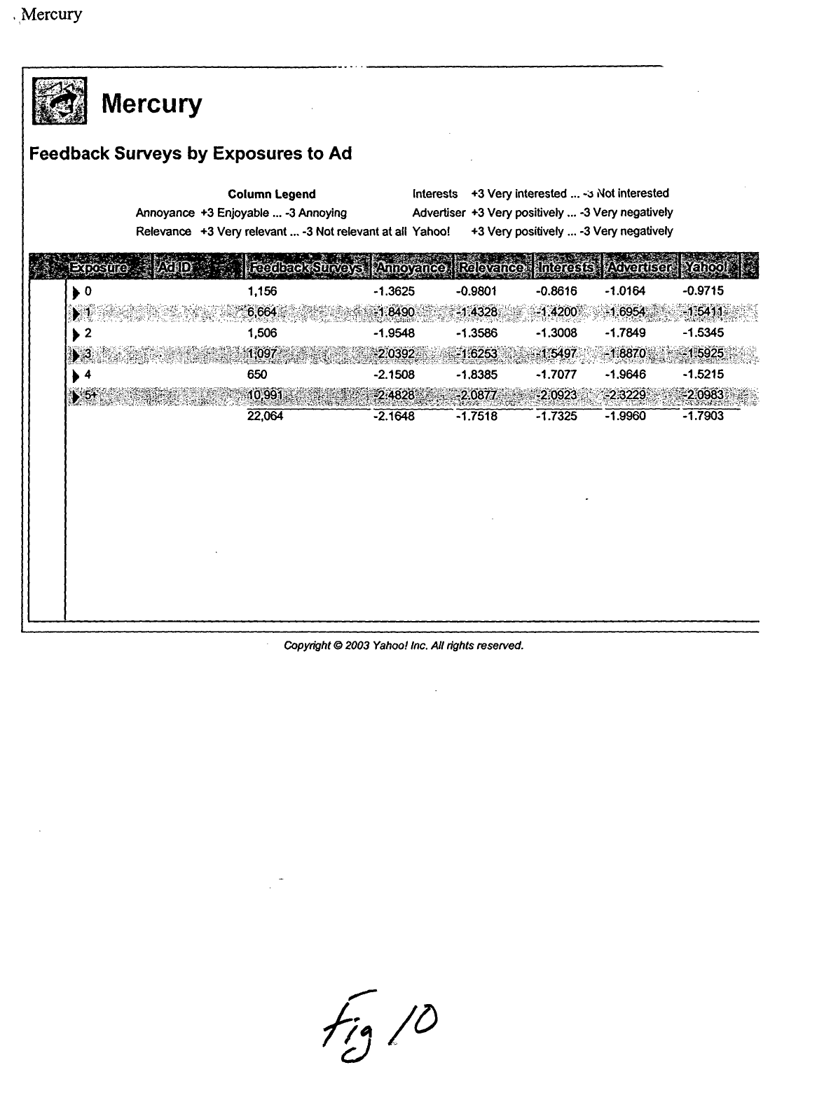

Data may also be grouped so that feedback received from surveys is compared with the number of exposures the survey respondent has had to the advertisement. For example, survey results are broken down by the number of times a user has viewed the advertisement ranging from 1 to, for example, greater than 5, as shown in FIG. 10. This is useful in determining whether, for example, there is overexposure of an advertisement, or whether a large response has been generated from a single viewing.

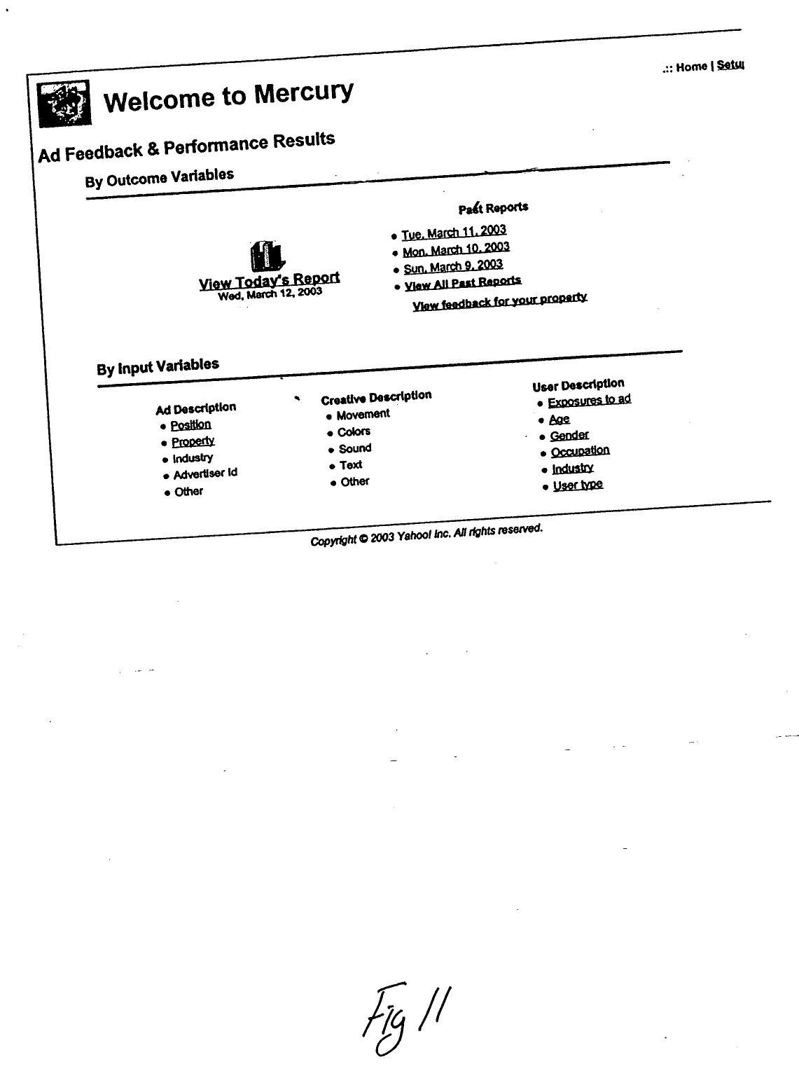

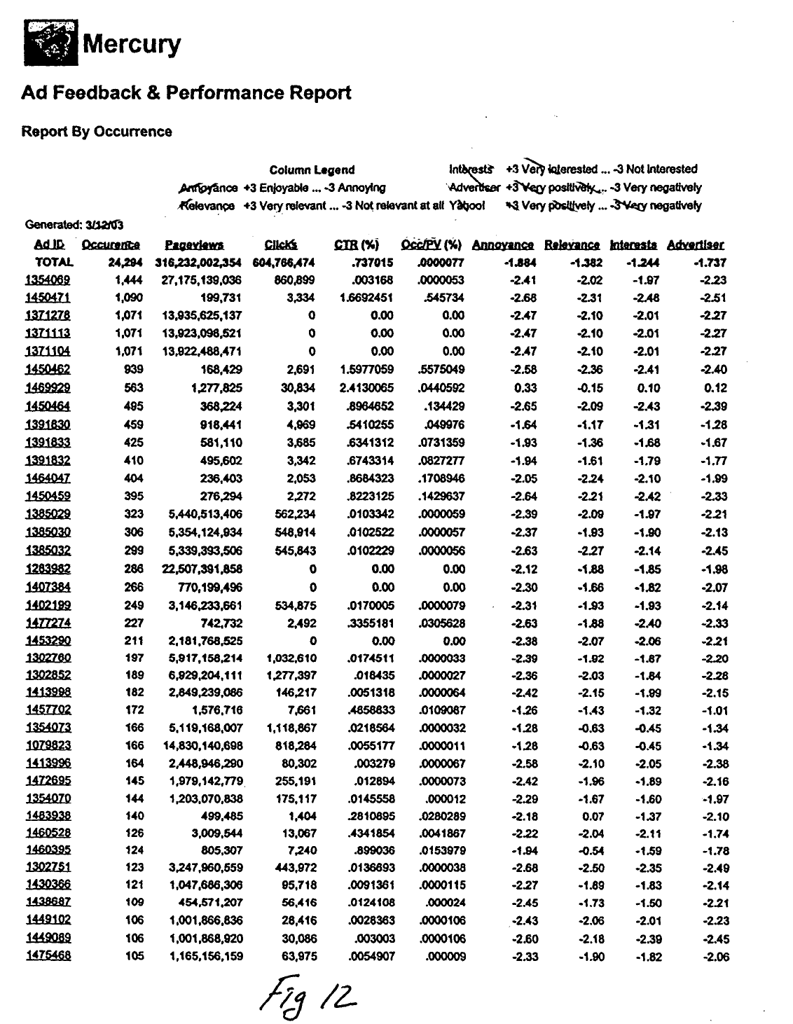

According to another aspect of the invention, a link is provide to a daily report, as shown in FIG. 11. The daily report provides a plurality of categories of outcome scores and variables, as shown in FIG. 12. These may include occurrence of the advertisement, page views, clicks, CTR, annoyance value and relevance, etc. This report is, for example, in table form and lists all of the advertisements using the assessment application. The advertisements are identified by an ID code, the Ad Id, and may be sorted by any of the above categories.

Yet another embodiment of the present invention relates to the calculation of various outcome scores corresponding to the effectiveness of an advertisement, for example, the UES of an advertisement. As discussed above, UES may be determined from data shown in FIG. 8.

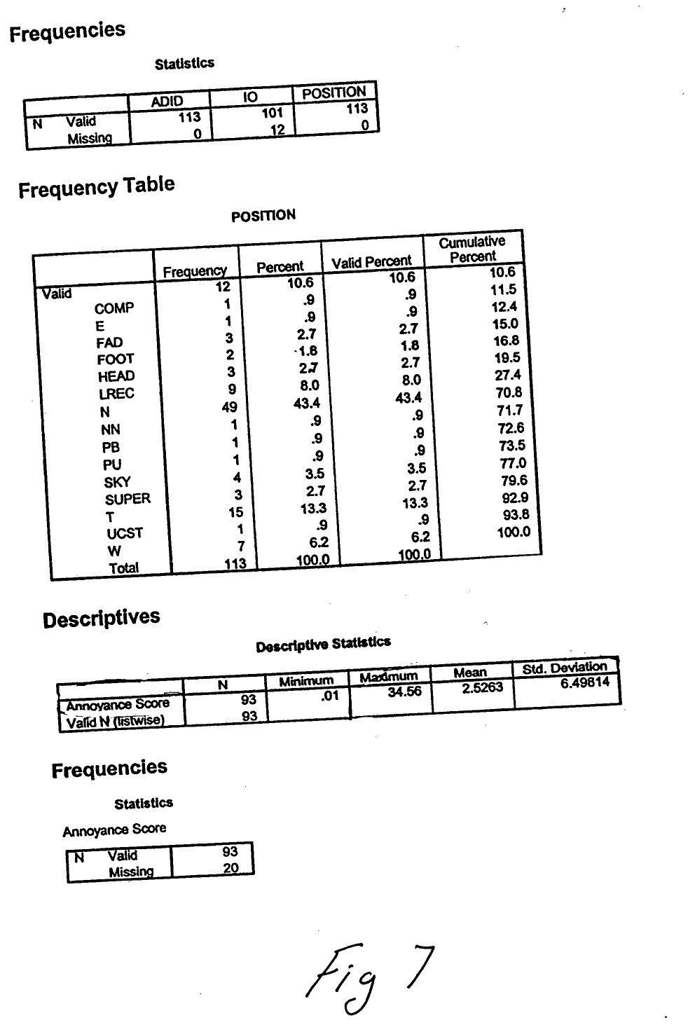

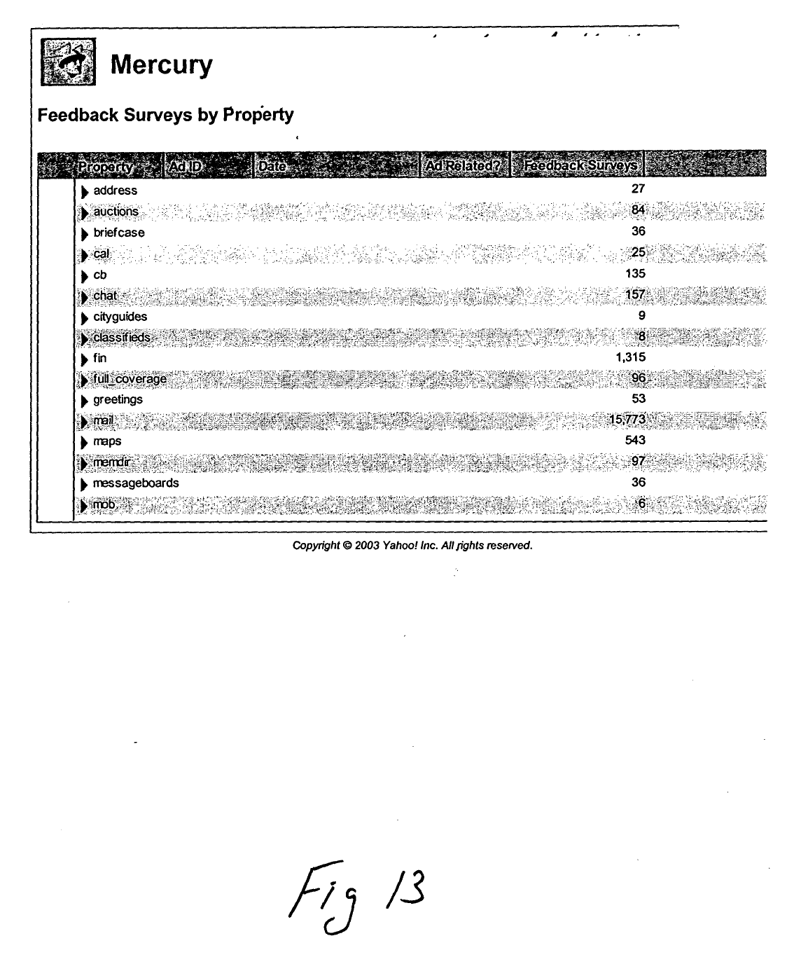

In addition, the data underlying the calculations are accessible to an Evaluator. These data may be broken down into other categories to analyze the effectiveness of an advertisement. For example, the data may be sorted by the position of the advertisement on a Web page, as shown in FIGS. 7, e.g., the “N” (north banner) or “LREC” (large rectangle) of the page. An advertiser, for example, may use several forms of an advertisement in a variety of positions on different Web pages. Certain positions may be more effective than others. Likewise certain locations may be more annoying than others. By grouping the advertisements by position, the Evaluator can determine if there are preferred positions for a specific advertisement that minimize annoyance. Another grouping, as shown in FIG. 13, lists the UES of multiple advertisements of a particular kind.

The application, according to a further aspect of the present invention provides information to optimize the effectiveness of advertisements from a specific advertiser. For example, where the advertiser wishes to target a particular demographic group, for example, women between the ages of 18 and 35, data regarding the effectiveness of advertisements that are particularly effective for this group, e.g. high UES scores for these types of viewers, the parameters of these advertisements may be used to suggest an advertisement type, a location, an exposure frequency and other characteristics. This data can be taken from a universal storage database (not shown) which stores data regarding previous advertisements and is searchable using user description values. Based upon the previous results of advertisers in similar industries with similar goods attempting to reach a similar demographic, a particular advertisement can be optimized.

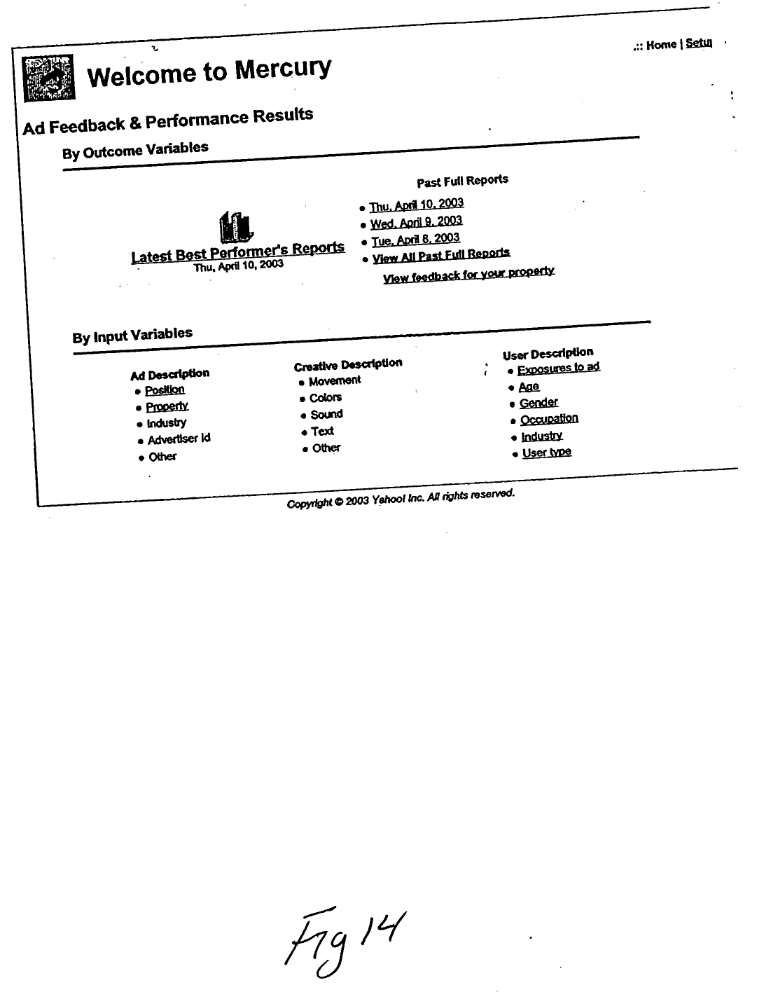

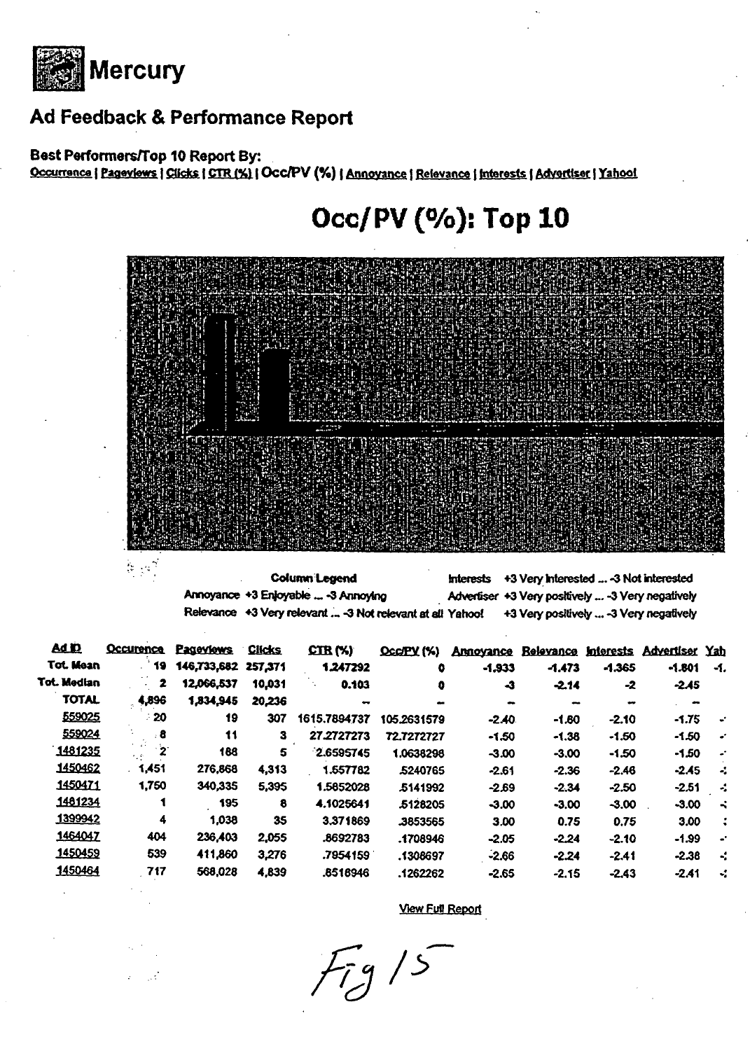

As shown in FIGS. 14 and 15, the performance scores can be grouped to show a variety of screens to the Evaluator FIG. 14 shows an entry page for comparison of several advertisements based upon the day's best performing advertisements. By clicking on the link, the Evaluator is directed to the best performer page, FIG. 15. In this instance the performance is calculated as the ratio of occurrences to page views expressed as a percentage. Other factors regarding the advertisement, such as annoyance, relevance, etc., are also displayed and the Evaluator may click on the headings (i.e. links) of these to see the underlying data.

In another aspect of the present invention, the information available to the Evaluator is updated daily, however other time frames may be used without departing from the scope of the present invention. By way of example, operation of the present embodiment as depicted in FIG. 16 will be discussed with information being updated daily.

FIG. 16 is a workflow diagram showing the operation of the Mercury system according to the present invention. Raw feedback data 12 including user feedback responses to survey questions and user specific information based on user cookies from database 13 are retrieved. Submitted survey responses are stored on secure internal servers 14. Agent 15 polls the internal server 14 for new data. If new data are found, the agent 15 purges the data of invalid and false entries and imports data to database 16 in a form that can be queried. Agents 17, 18 and 19 decode data fields, remove unwanted ad data and update the database's index for better performance. The resultant data are then merged with data from a statistics database 20 for objective performance variables and with data from the ad information database 21 for the ad and creative description variables. Performance scores of the advertisement are calculated by the application, and the various tables associated with variables and scores are assembled. The results are stored in application database 22. Reports are generated in response to Evaluator queries in a flexible text format adapted for large-scale electronic publishing such as extensible Markup Language (XML) 23. However, for presentation to an Evaluator, the XML data are typically translated using XML Stylesheet Transformations (XSLT) 24 to a browser language such as Hyper Text Markup Language (HTML). Reports are presented as a series of Web page screens 25 connected by links that refer to various calculations and underlying variables.

In yet another embodiment of the present invention, there is provided a computer network for accommodating the computer application described above. The computer network provides storage devices, servers, access points, processors, and other components for performing the tasks of the computer application discussed above. The application, which is run from a computer located on the network, utilizes the access provided by the network to external databases for the retrieval of input and outcome variables, as discussed above. Further, the computer network allows for the retrieval of the stored feedback information resulting from the surveys that have been filled out by viewers of the advertisement. Through this network, the application is able to gain access to the variables necessary for the calculations. Further, this information is repackaged in a more usable form by the application resulting in a single source located on the network for viewing all of the relevant advertisement information necessary for calculating effectiveness.

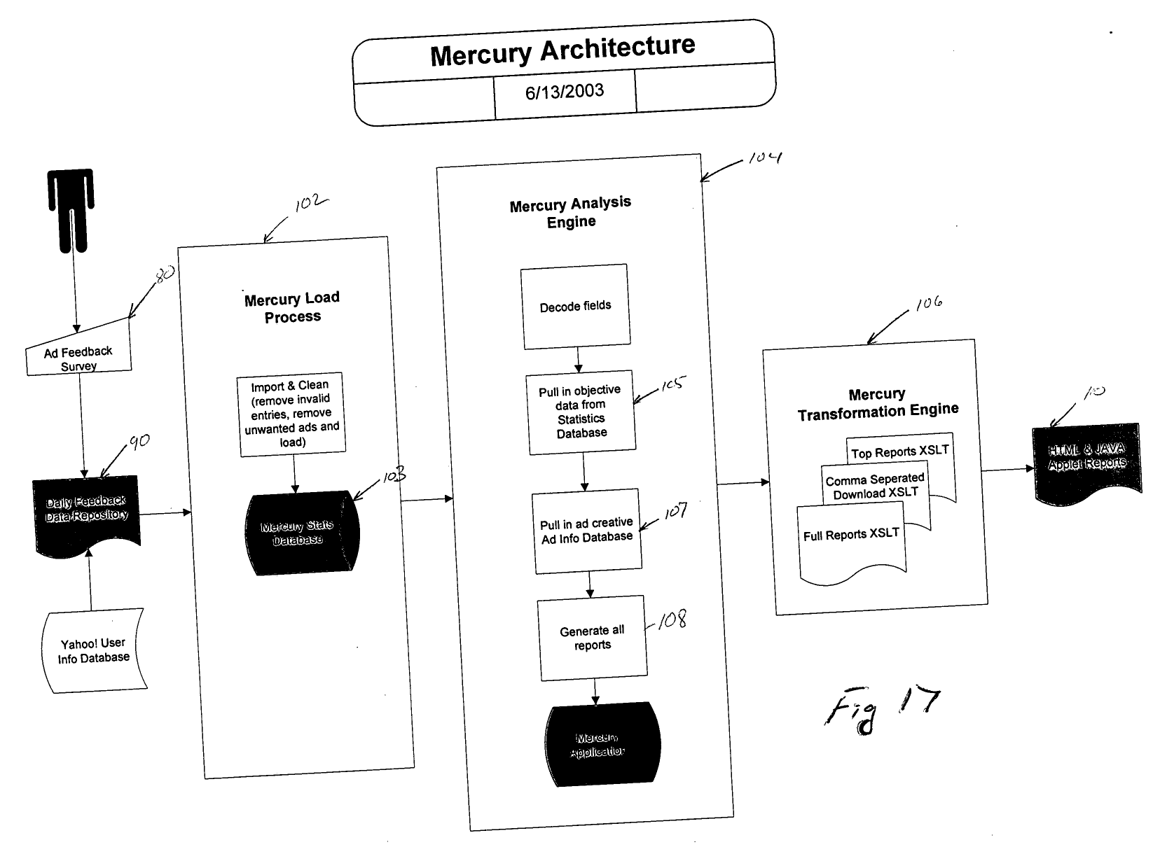

FIG. 17 shows a system architecture according to this embodiment broken down into three components: load processing 102, analysis engine 104, and transformation engine 106. The load process 102 interfaces with the data repository 90 and imports the data into a query-able statistics database of user feedback data 103. The analysis engine 104 calculates the effectiveness of advertisements by pulling in objective data attributes 105, ad creative attributes 107 and the distribution of values from the feedback data 90 and puts in into a report 108 composed of XML attributes and values. The transformation engine 106 transforms the XML report into a series of Web pages and JAVA applets 110 for viewing.

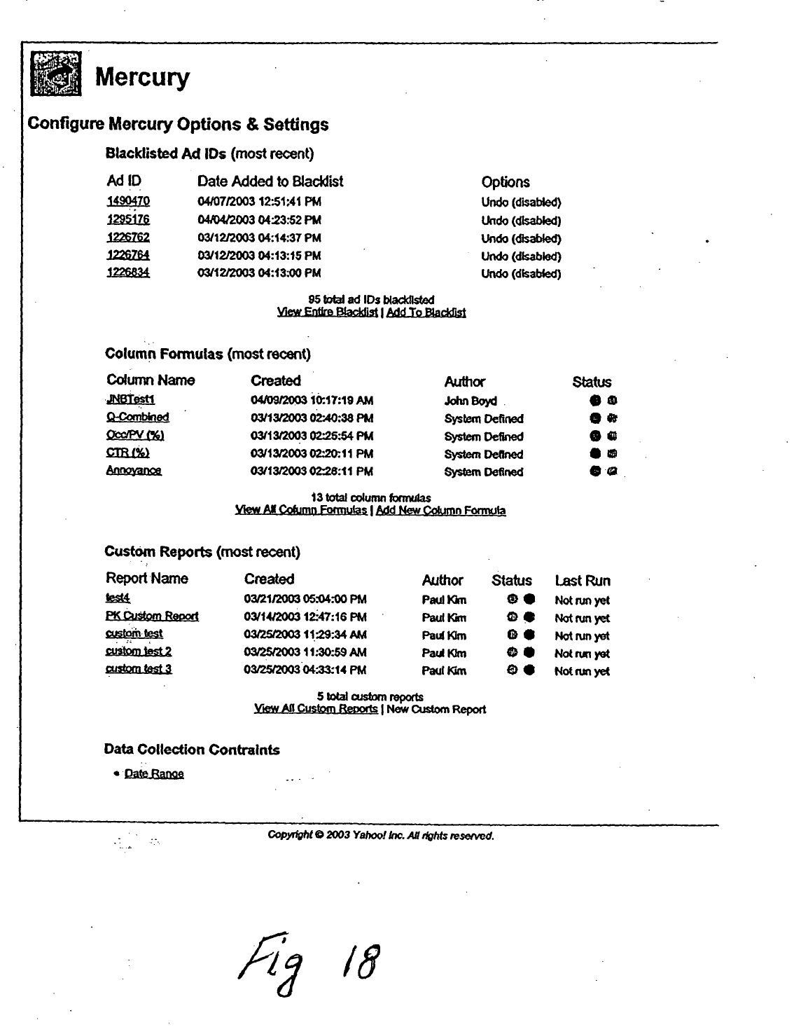

The contents of the web page displayed to evaluators and the formulas used to calculate scores can be modified by a system administrator and are tailored to suit a particular Evaluator. The administrator accesses the formulas for the various calculations by entering an options and settings page, as shown, for example, in FIG. 18. Optionally, the administrator can blacklist advertisements, create or amend column formulas, and create or amend custom reports.

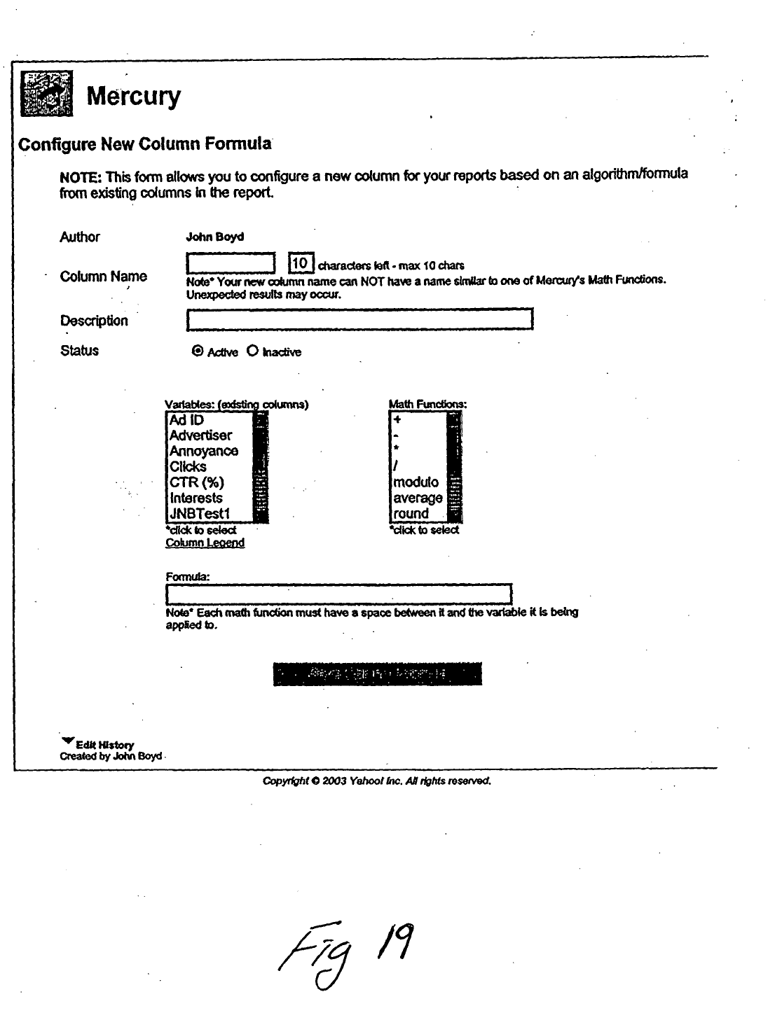

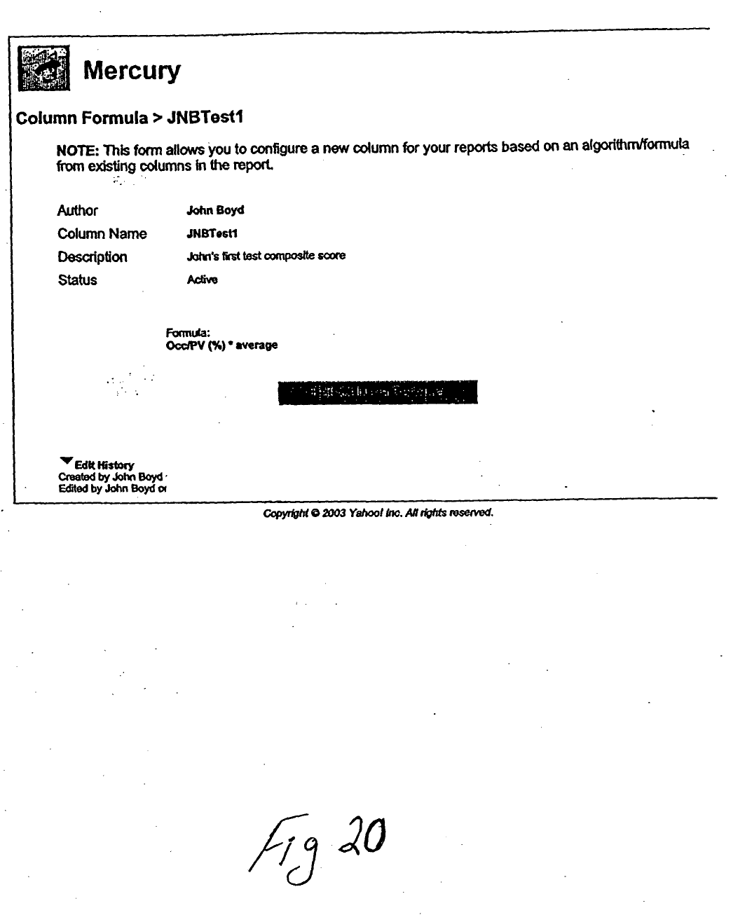

For example, by clicking on the column formulas link, the administrator is directed to a new column formula page, such as that shown in FIG. 19. The administrator then enters a formula by incorporating available variables into mathematical functions. Once established, the column is accessed by the administrator through a page such as the one shown in FIG. 20. The administrator reviews the column formula and also amends it as desired. The new column is displayed to the Evaluator upon entry to the web page following the next regularly scheduled update, e.g., daily.

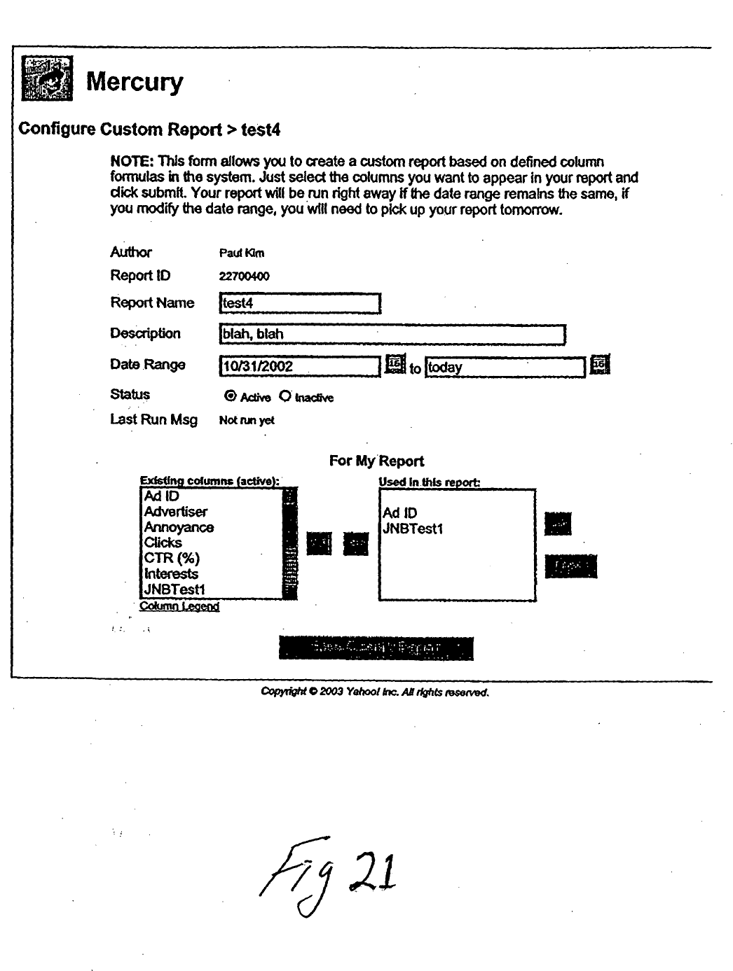

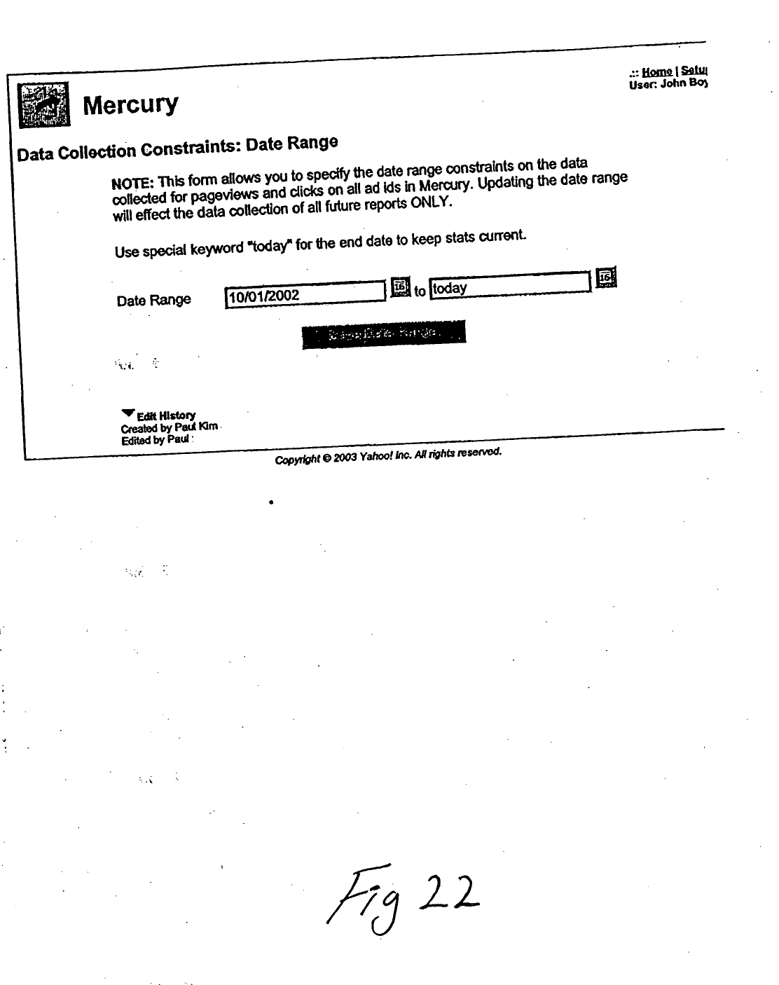

As shown in FIG. 21, the administrator can generate custom reports. This enables the application to display different information or formats to different Evaluators. The administrator adds the various columns that an Evaluator requires. These columns then will appear on the report when accessed by the Evaluator. Any underlying data necessary to generate these columns is also available to the Evaluator via links associated with the various column headings. In addition, FIG. 22 shows that the administrator can limit the time frame of data to be presented in the report.

The present invention has been described as enabling comparison of advertisements, however, other functions also exist. One of these additional functions is the ability of the invention to detect web site clutter. By comparing the feedback from the surveys with data related to the number of advertisements on a site or the number of pixels dedicated to advertisement the Evaluator is able to consider whether clutter on a web site adds or detracts from the effectiveness of an advertisement.

Another function considered within the scope of the present invention is the ability for service providers to ascertain the brand awareness created by an advertisement. One method of doing this is to monitor the search terms that a user inputs into the media owner's search engine. An agent views the L and B cookies of a user. These cookies include where a user had been on the web and other information about the user. By cross referencing the user information from the cookies with searches performed by the service provider, the search terms entered by that user can be ascertained.

A brand awareness factor is calculated by comparing the user's search terms to the advertisements displayed to the user. For example, if a user sees four advertisements for Mercedes-Benz automobiles on various web pages and subsequently performs a search using terms like “luxury car,” the correlation of these facts indicates that a brand awareness has been created at least partially due to the presentation of the advertisements. A metric is determined that quantifies the advertisement's effectiveness in creating brand awareness.

The present invention can also be used by advertising professionals as a part of a platform for creative testing. According to one embodiment of the invention, a series of advertisements are created, each varying one or more specific features, such as the color or animations. Survey results collected in response to the ads are then correlated with different instances of varied features to establish which instances make the ad most effective. For example by changing a background color or certain wording it can be determined whether the UES increased or decreased, i.e. whether the ad is more or less annoying.

Another aspect of the invention is that it can be used as an ad warehouse that can store the ad descriptions of the various advertisements. In one embodiment of the invention, the ad descriptions and other characteristics are stored in a universal storage database (UDB). Alternatively, an agent could query the various databases shown in FIG. 16, which store a variety of information regarding the advertisement. Where a UDB is used, the UDB stores characteristics of the advertisement including the calculated performance scores, the focus or purpose of the advertisement, the ad description, user descriptions, and the like. An advertisement professional can then perform a query to optimize characteristics of a new advertisement for a product. By ascertaining how previous advertisements performed regarding a product, or a particular demographic, advertisers are able to perform predictive advertisement generation.

In one embodiment, the user enters a series of parameters into a query table. For example, an advertisement professional may enter the product type, the time of year for the marketing campaign, the desired demographic, the media in which the ad is to run, the proposed location of the advertisement, the proposed position of the advertisement, the size, and the like. An agent utilizes the parameters to scan the UDB of previous advertisements and produce a list of advertisements having similar parameters. The list also shows the performance scores of these ads. This list enables the advertisement professional to predict the outcome of a proposed advertisement, as well as provide indication of changes that could be made to increase the effectiveness of the advertisement.

In another aspect of the invention survey data are used as part of the customer service tools for a company. In one embodiment, a survey similar to that in FIG. 3, but directed to customer service concerns instead of an advertisement, is provided for a web page. Through the use of metrics, performance scores for the web page can be ascertained. Functionally, this embodiment operates in a similar manner to the ad feedback embodiment described above. There may be provided a link on a website entitled “Customer Service Survey.” Through the use the survey, feedback data from customers is gathered and processed by the application as shown in FIG. 17, except that Ad Info is replaced with Website Info in element 107. The survey provides information for an Evaluator regarding how to better meet the needs of customers. Such an application can use both the value-based answers and the text based answers to perform calculations and provide Evaluators with information regarding the effectiveness of a website. The data from the surveys may be combined with data regarding the website sales, or performance to produce performance metrics for the website. The data can also be used to ascertain specific problems with a website.

One important area of concern for many website owners is that of un-finalized sales of products. By using the system described above, it is possible to ascertain at what point in a check-out procedure users tends to stop processing a sale. Often one of the steps in the check-out procedure is long or complicated and results in users loosing interest in finalizing the sale. By targeting and understanding where in a process this occurs, the step can be eliminated or to the extent possible the burden on the purchaser can be reduced. The survey data from customers who have stopped sales, or who completed sales but were somehow frustrated by the process is combined with the website data showing how many sales were stopped and at what point in the process they were stopped. This process utilizes both objective data and subjective feedback, and provides the Evaluator a complete picture of the purchasing patterns of users and the effectiveness or efficiency of a web page.

A still further aspect of the invention is to track actual user actions following submission of a survey. Often it occurs that in the response data of the survey a user will threaten to cease using a particular product, service, or application. For example, a viewer may claim to be so outraged by an advertisement that they threaten to cease using the service. Utilizing an agent, responses to surveys can be monitored for threatening language. The agent determines the user identity and queries the L cookies of that user. The agent tracks the user to determine whether the threatened action is fulfilled. The agent tracks the L cookies of the user to determine whether any change in the patterns of that particular user is noted to determine if the threatened action has occurred (e.g. never visiting a particular application again). The tracking can occur on a regular basis, such as weekly, or monthly and may have a cut-off period of a set duration where tracking ends. By tracking the L cookies of a person who make such threats, a metric can be developed to determine statistically how often such a threat is carried out. This metric can then be included into the calculations for performance scores.

Another aspect of the invention is to create advertising scheduling to optimize the display of effective advertisements. The advertisements that have better performance scores are shown more frequently, whereas advertisements that do not perform well can be removed from circulation. In one embodiment of the invention, an agent gathers the performance scores of the advertisements appearing in a specific media, this may be from the database 22 shown in FIG. 16, for example. The agent forms a table of the performance scores of the ads. The table is cross-referenced to a circulation table. In the circulation table a hierarchical structure is developed so that advertisements with the best performance scores will be shown most often. The correlation of presentations of an advertisement with performance scores enables the media owner to update the advertisements that are being shown most on their media based upon performance. The Evaluator can then review the table and determine whether to remove certain poorly performing ads or to add new ads to circulation.

This application indicates advertisement bum-out. As an advertisement becomes overexposed to the viewers its performance scores will drop. By monitoring performance scores the Evaluator can remove advertisements from circulation where their scores begin to drop. According to another embodiment, advertisements are automatically removed from circulation by an agent when their performance scores drop below a certain level. New advertisements are added to the circulation of displayed advertisements. This embodiment limits the over exposure of advertisements and the display of advertisements that perform poorly.

While the invention has been described in connection with what is considered to be the most practical and preferred embodiment, it should be understood that this invention is not limited to the disclosed embodiments, but on the contrary, is intended to cover various modifications and equivalent arrangements included within the spirit and scope of the appended claims.

What is claimed:

1. A method of determining the performance of an advertisement comprising:
collecting a plurality of input data points;
collecting a plurality of outcome data points; and
calculating one or more performance scores based upon the input and output data points.

2. The method according to claim 1, wherein the input data points include one or more of advertisement description data points, creative description data points, and user description data points, and wherein the outcome data points include one or more of objective data points, subjective data points, and user experience data points.

3. The method of claim 1, wherein the one or more performance scores are accessible to an Evaluator through a computer-based application.

4. The method of claim 1, wherein the data points are accessible to an Evaluator through a computer-based application.

5. The method of claim 2, wherein the performance scores include a composite performance score.

6. The method of claim 2, wherein the performance scores include a user experience score.

7. The method of claim 2, wherein the performance scores include a subjective performance score.

8. The method of claim 2, wherein the performance scores includes an objective performance score.

9. The method of claim 1 further comprising:
displaying a survey concerning the advertisement to one or more users;
collecting the results of the survey; and
calculating at least one of the performance scores based on the survey results.

10. The method of claim 9, wherein the survey is presented to the one or more users as a pop-up window.

11. The method of claim 9, wherein the survey is accessed by the user via a link associated with the advertisement.

12. The method of claim 9, wherein the survey solicits text comments.

13. The method of claim 12, wherein the text comments are viewable by an Evaluator.

14. The method of claim 9, wherein a user experience score is calculated using the survey.

15. The method of claim 9, further comprising:
analyzing the text comments to identify key words;
assigning numeric values to the identified key words; and
calculating the subjective performance score based at least in part on the numeric values.

16. The method of claim 9, wherein the text comments are viewable by an Evaluator.

17. The method of claim 2, wherein user description data points are determined from cookies.

18. The method of claim 2, wherein the ad description data points are downloadable from one or more external data collection databases.

19. The method of claim 2, wherein the creative description data points are downloadable from one or more external data collection databases.

20. A computer application for evaluating an advertisement, the application comprising:
objective data collecting means for collecting a plurality of objective data points regarding the advertisement;
subjective data collecting means for collecting a plurality of subjective data points regarding the advertisement;
user experience data collecting means for collecting a plurality of user experience data points regarding the experience of one or more user that have viewed the advertisement;
advertisement description data collecting means for collecting a plurality of advertisement description data points regarding characteristics of the advertisement;
creative description data collecting means for collecting a plurality of creative description data points regarding the content of the advertisement;
user description data collecting means for collecting a plurality of user description data points regarding characteristics of one of more users; and
calculating means for calculating one or more performance scores from the plurality of data points.

21. The computer application of claim 20, further comprising a means to present one or more performance scores to an Evaluator.

22. The computer application of claim 20, further comprising means to present the data points to an Evaluator.

23. The computer application of claim 20, wherein one of the performance scores is a composite performance score.

24. The computer application of claim 20, wherein one of the performance scores is a user experience score.

25. The computer application of claim 20, wherein one of the performance scores is a subjective performance score.

26. The computer application of claim 20, wherein one of the performance scores is an objective performance score.

27. The computer application of claim 20, further comprising means to download data from external collection databases.

28. The computer application of claim 20, further comprising:
means for displaying a survey concerning the advertisement to one or more users;
means for collecting the results of the survey; and
means for calculating one or more performance score based on the survey results.

29. The computer application of claim 28, wherein the survey is displayed to the one or more users as a pop-up window.

30. The computer application of claim 28, wherein the survey is accessed by the user via a link associated with the advertisement.

31. The computer application of claim 28, wherein the survey solicits text comments.

32. The computer application of claim 31, wherein the text comments are viewable by an Evaluator.

33. The computer application of claim 32 further comprising:
analyzing means for analyzing the text comments to identify key words;
assigning means for assigning numeric values to the analyzed words; and
calculating the subjective performance score based at least in part on the numeric values.

34. The computer application of claim 20, further comprising cookie inspection means for determining user description data points from cookies.

35. The computer application of claim 27, wherein the ad description data points are downloaded from the one or more external data collection databases.

36. The computer application of claim 27, wherein the creative description data points are downloaded from the one or more external data collection databases.
